(19) United States
(12) Patent Application Publication
(10) Pub. No.: US 2009/0103329 A1
(43) Pub. Date: Apr. 23, 2009

(54) Combination of electrical socket and night lamp

(76) Inventors: Ching-Huei Wu, San Chung City (TW); Tai-Ho Huang, San Chung City (TW)

Correspondence Address: TROXELL LAW OFFICE PLLC, SUITE 1404, 5205 LEESBURG PIKE, FALLS CHURCH, VA, 22041, US

(21) Appl. No.: 11/976,101

(22) Filed: Oct. 22, 2007

(51) Int. Cl. H01R 33/00

(52) U.S. Cl. 362/642

(57) ABSTRACT

An electrical device is formed by a combination of an electrical socket and a night lamp and includes a housing, a circuit board, at least one light-emitting diode, at least one socket, a sensor and a panel. The circuit board and the at least one socket are arranged inside the housing. The circuit board is electrically connected to an external power source and is also electrically connected to the at least one light-emitting diode and the sensor so that the sensor is electrically connected to the at least one light-emitting diode via the circuit board to form a circuit. The panel is releasably mounted to the housing and forms an opening corresponding to each of the at least one socket to expose the socket.

### BACKGROUND OF THE INVENTION

1. Field of the Invention

The present invention relates to a structure of a combination of an electrical socket and a night lamp, and in particular to an assembly comprising a housing, a circuit board, at least one light-emitting diode, at least one socket, a sensor, and a panel, wherein the circuit board is electrically connected to a power source and is further connected to the at least one light-emitting diode and the sensor so that the sensor is electrically connected to the at least one light-emitting diode via the circuit board to form a circuit applicable to an electrical socket device or the likes.

2. The Related Arts

A night lamp that is commonly available in the market is designed to plug into an electrical socket of a wall outlet and is actuated manually by a user in accordance with the surrounding lighting condition. Alternatively, the night lamp may be provided with a sensor to detect the surrounding lighting condition for automatic actuation.

The known night lamp is an individual device that must be provided with a plug or other connector for electric connection with an external power source, such as a wall outlet. Further, the night lamp can only work by being plugged into a wall outlet or other electrical socket to receive the external power source. Thus, to use the night lamp, a user must first search for an available wall outlet or electrical socket and the wall outlet or electrical socket into which the night lamp is plugged is thus occupied. This causes problems in using other electrical devices. Further, the conventional night lamp gives off light through a light bulb, which, as generally known, is very power consuming and takes more power than for example a light-emitting diode.

Thus; the present invention is aimed to provide an electrical device that can serve as a night lamp but occupying no electrical socket or wall outlet to overcome the above discussed drawbacks.

### SUMMARY OF THE INVENTION

An objective of the present invention is to provide an electrical device that is formed by a combination of an electrical socket and a night lamp, comprising an assembly of a housing, a circuit board, at least one socket, at least one light-emitting diode, a sensor, and a panel, wherein the housing accommodates the circuit board, which is electrically connected to a power source and is further connected to the at least one light-emitting diode and the sensor so that the sensor is electrically connected to the at least one light-emitting diode via the circuit board to form a circuit applicable and that when the sensor detects the insufficiency of surrounding lighting, the at least one light-emitting diode is actuated to give off light, serving as a night lamp, and wherein since the night lamp is integrated in the socket associated with the power source, there is no need to seek for a wall outlet when it is attempted to use the night lamp and further occupation of the wall outlet by the night lamp is eliminated, removing the inconvenience that other electrical devices find no wall outlet to plug in, and further using the light-emitting diode as a light source provides illumination in an extended period of time and being easy to operate.

Another objective of the present invention is to provide an electrical device formed by a combination of an electrical socket and a night lamp, wherein at least one light-emitting diode is incorporated as light source that is selectively arranged inside a housing or outside the housing to enhance the practicability and convenience of the electrical device and night lamp.

To realize the above objectives, in accordance with the present invention, there is provided an electrical device comprising a housing, a circuit board, at least one light-emitting diode, at least one socket, a sensor, and a panel. The housing forms an interior space and the circuit board is arranged in the interior space of the housing. The circuit board is electrically connected to the at least one light-emitting diode. The circuit board is also electrically connected to an external power source. The at least one socket is arranged inside the housing and is electrically connected to the external power source. The sensor is arranged inside the housing and is electrically connected to the circuit board so that the sensor is electrically connected to the light-emitting diode and the external power source via the circuit board to form a circuit. The panel is releasably mounted to the housing and forms an opening corresponding to each of the at least one socket. With such an arrangement, an electrical device comprising a combination of an electrical socket and a night lamp is provided, which demonstrates enhanced practicability and convenience.

The present invention will become more obvious from the following description when taken in connection with the accompanying drawings, which show, for purposes of illustration only, preferred embodiments in accordance with the present invention. In the drawings:

### BRIEF DESCRIPTION OF THE DRAWINGS

FIG. 1 is a perspective view showing an electrical device formed by a combination of an electrical socket and a night lamp in accordance with an embodiment of the present invention;

FIG. 2 is an exploded view of the electrical device in accordance with the present invention;

FIG. 3 is a cross-sectional view of the electrical device in accordance with the present invention;

FIG. 4 is a perspective view illustrating a practical application of the electrical device in accordance with the present invention; and

FIG. 5 is a perspective view illustrating an application of an electrical device formed by a combination of an electrical socket and a night lamp in accordance with another embodiment of the present invention.

### DETAILED DESCRIPTION OF THE PREFERRED EMBODIMENTS

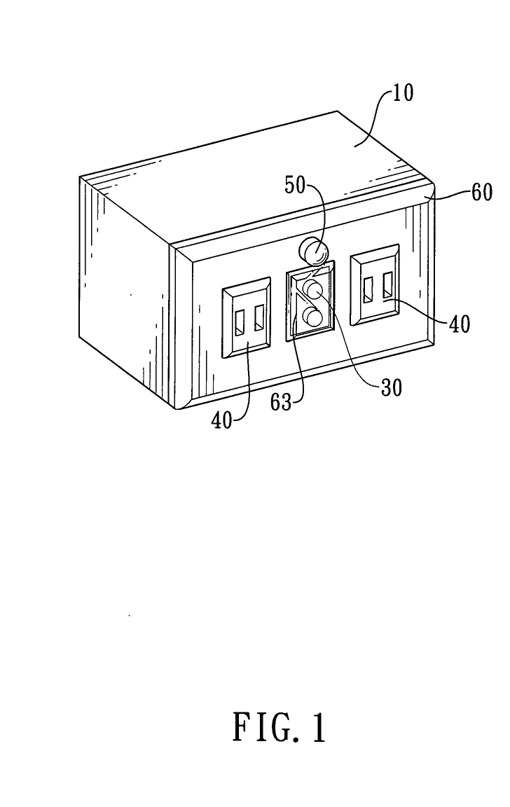

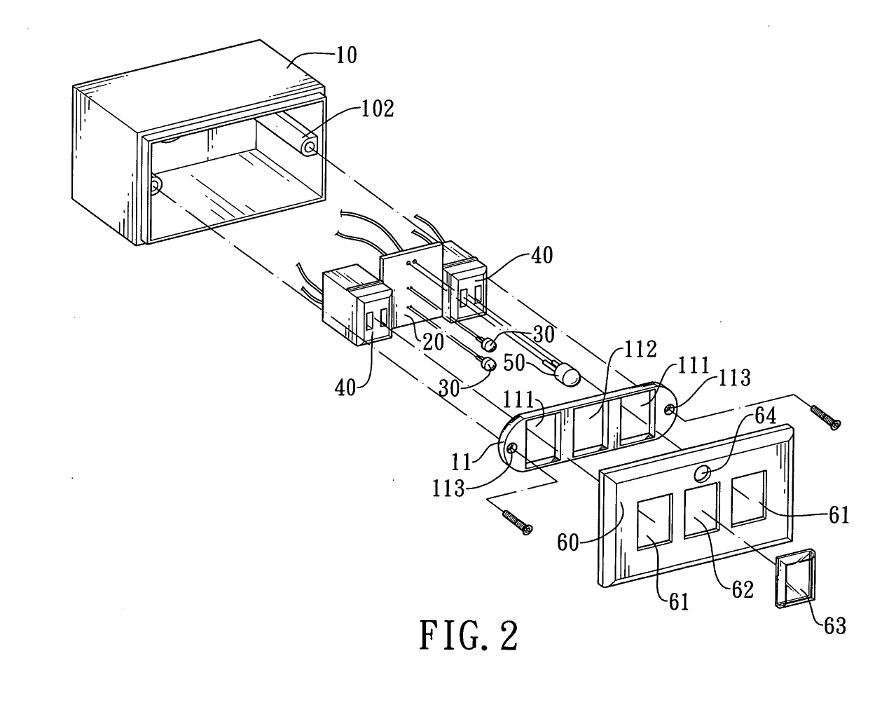

With reference to the drawings and in particular to FIGS. 1-3, an electrical device constructed in accordance with the present invention by combining a night lamp with an electrical socket device is illustrated. The electrical device that comprises a combination of the night lamp and the electrical socket device comprises a housing 10 in which an interior space is defied for accommodating a circuit board 20, at least one socket 40, and a sensor 50 through an opening (not labeled) and a panel 60 mounted to and closing the opening of the housing 10.

The circuit board 20 is accommodated in the interior space of the housing 10 and is electrically connected to an external power source 70. The circuit board 20 forms thereon a power supply circuit and a control circuit. The circuit board 20 is in electrical connection with at least one light-emitting diode 30. In the embodiment illustrated, the at least one light-emitting diode 30 is mounted on the circuit board 20; however the light-emitting diode 30 can be arranged at a location offsetting from the circuit board 20 and at any location inside or outside the housing 10. When the light-emitting diode 30 is set outside the housing 10, the light-emitting diode 30 can be electrically connected to the circuit board 20 by a length of electrical wire.

The at least one electric socket 40 is also arranged inside the housing 10 and is electrically connected to the external power source 70. In the embodiment illustrated, two electrical sockets 40, which constitute together the electrical socket device, are included in the housing 10. The electrical sockets 40 can be set at any desired location inside the housing 10 and electrically connected to the external power source through electrical wires, though they are set at locations corresponding to the front opening of the housing 10 in the embodiment illustrated.

The sensor 50, preferably similarly accommodated inside the hosing 10, is electrically connected to the circuit board 20 and is further electrically connected to the at least one light-emitting diode 30 and the external power source 70 through the circuit board 20 to thereby form a circuit. In the embodiment illustrated, the sensor 50 is mounted on the circuit board 20 accommodated inside the housing 10, but it is apparent that the sensor 50 can be arranged at any desired location inside the housing 10 and/or the sensor 50 can be set outside the housing 10, wherein in both cases, the sensor 50 is electrically connected to the circuit board 20 by for example electrical wires.

The panel 60 is mounted to the housing 10 to cover the opening of the housing 10. Preferably, the panel 60 is mounted to the housing in a releasable manner. The panel 60 forms an opening 61 corresponding to each of the at least one socket 40. A retainer plate 11 is further provided inside the housing 10. However, it is noted that if desired, the retainer plate 11 can be removed, and under this situation that the retainer plate 11 is removed, with the at least one light-emitting diode 30 set inside the housing 10, the panel 60 is made light-transmittable to allow light emitted from the light-emitting diode 30 to transmit therethrough; or alternatively, the panel 60 can be made non-light-transmittable, and instead, a through hole 62 is formed in the panel 60 at a location corresponding to each of the at least one light-emitting diode 30 and an additional light-transmitting cap 63 is provided to cover the through hole 62 of the panel 60 so that the light emitted from the light-emitting diode 30 is allowed to transmit to outside the housing 10 through the through hole 62 and the light-transmitting cap 63. In addition, in case that the sensor 50 is also arranged inside the housing 10, the panel 60 forms a further opening or through hole 64 corresponding to and exposing the sensor 50.

The retainer plate 11 is arranged between the panel 60 and the housing 10 and forms an opening 111 corresponding to each of the at least one socket 40. The opening 111 of the retainer plate 11 corresponds to the opening 61 of the panel 60 that is formed in association with each of the at least one socket 40 for properly positioning the socket 40 in such a way that the socket 40 is exposed through or extends through the opening 61 defined in the panel 60. In the embodiment illustrated, since two sockets 40 are arranged inside the housing 10, the retainer plate 11 forms two openings 111 corresponding to the sockets 40, and similarly, the panel 60 also forms two openings 61 corresponding to the sockets 40 and the openings 111 of the retainer plate 11. In case that the at least one light-emitting diode 30 is arranged inside the housing 10 and the retainer plate 11 is set inside the hosing 10 and is provided with a through hole 112 corresponding to each of the at least one light-emitting diode 30, the panel 60 can be made light-transmittable to allow light emitted from the light-emitting diode 30, which travels through the through hole 112 of the retainer plate 11, to transmit therethrough; or alternatively, the panel 60 can be made non-light-transmittable, and instead, a through hole 62 is formed in the panel 60 at a location corresponding to each through hole 112 formed in the retainer plate 11 and also at the direction along which the light emitted from the associated light-emitting diode 30 travels, an additional light-transmitting cap 63 being provided to cover the through hole 62 of the panel 60, so that the light emitted from the light-emitting diode 30 is allowed to transmit to outside the housing 10 through the through holes 112 and 62 of the retainer plate 11 and the panel 60 and the light-transmitting cap 63. In addition, in case that the sensor 50 is also arranged inside the housing 10, the panel 60 forms a further opening or through hole 64 corresponding to and exposing the sensor 50.

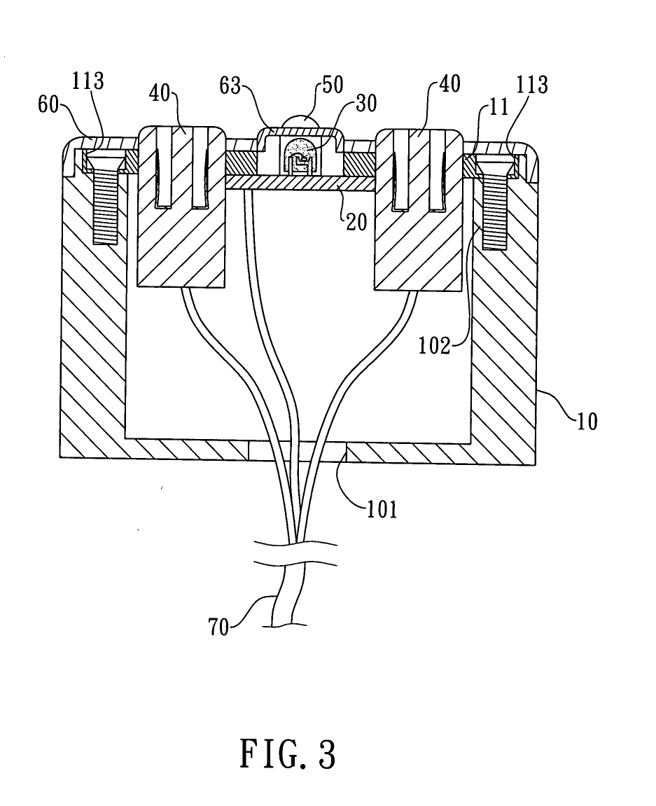

In the embodiment illustrated, the circuit board 20 is arranged between the two sockets 40. However, it is note that the circuit board 20 can be set at any desired location in the interior space of the housing 10. The housing 10 forms a passage 101, see FIG. 3, preferably at a rear wall thereof, to allow the circuit board 20 and the at least one socket 40 to electrically connect to the external power source 70. In the embodiment illustrated, the retainer plate 11 forms mounting holes 113 on opposite lateral edges thereof. Two mounting portions 102 are formed inside the housing 10 and at opposite side walls of the housing 10, and each mounting portion 102 forms a mounting hole corresponding to the mounting hole 113 of the retainer plate 11. Thus, a fastener, such as a bolt or screw, is received through each of the mounting holes 113 of the retainer plate 11 and engages the mounting hole of the corresponding mounting portion 102 of the housing 10 to secure the retainer plate 11 to the housing 10.

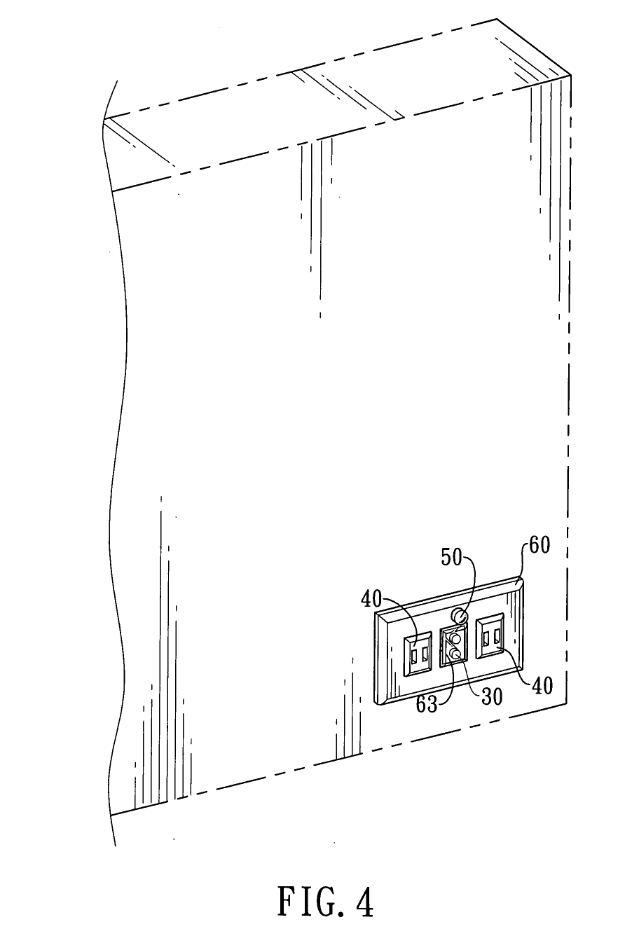

Also referring to FIGS. 1-5, the electrical device of the present invention features an assembly of a housing 10, a circuit board 20, at least one light-emitting diode 30, at least one socket 40, a sensor 50, and a panel 60 with the housing 10 accommodated in a cavity defined in a building wall which is provided to accommodate a wall outlet and the circuit board 20 fixed inside the housing 10. The circuit board 20 is electrically connected to the external power source 70, which can be the electrical main that is designated to supply power to the wall outlet. The circuit board 20 is further electrically connected to the at least one light-emitting diode 30 and the sensor 50, so that the sensor 50 is electrically connected to the light-emitting diode 30 via the circuit board 20, forming a circuit. Thus, when the sensor 50 detects dimming or insufficiency of the surrounding lights, the light-emitting diode 30 is activated to give off light, serving as a night lamp. In this way, there is no need to provide separate socket and night lamp and the space that was originally designated to accommodate a regular wall outlet socket is sufficient to accommodate both an electrical socket and a night lamp. Consequently, the installation of the night lamp does not occupy the space of the wall outlet and still allows other electrical appliance to be powered by plugging into the socket that is integrated with the night lamp. Certainly, this arrangement of the present invention enhances the convenience of using electrical socket and night lamp and also improves the overall aesthetics of the electrical arrangement.

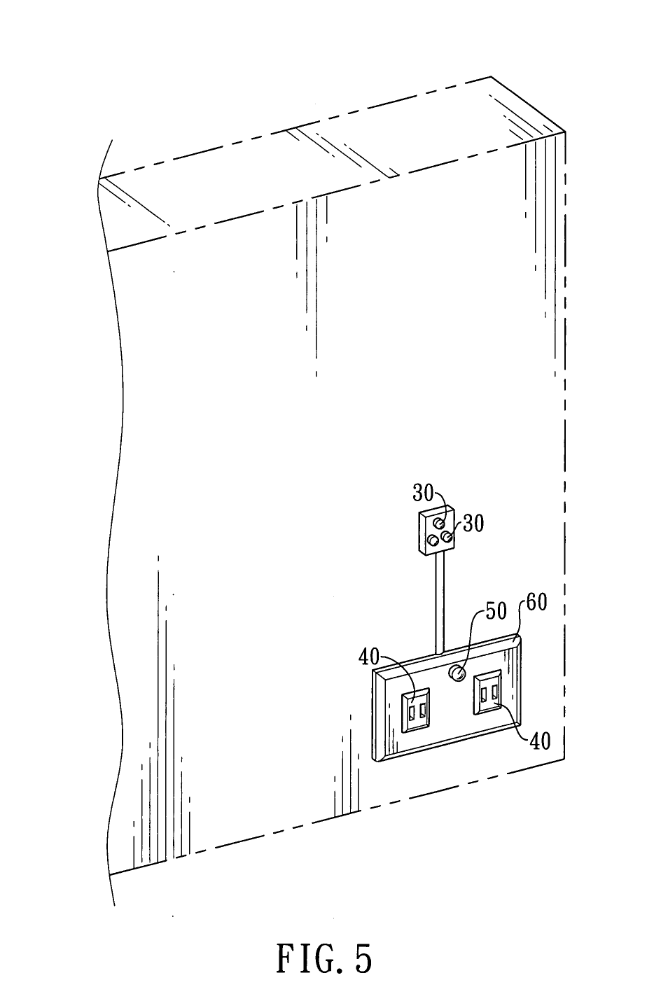

Particularly referring to FIG. 5, which illustrates another arrangement in accordance with the present invention, the light-emitting diode 30 can be alternatively arranged outside the housing 10 and is electrically connected to the circuit board 20 via proper electrical connection, such as electrical wires. The sensor 50 is arranged inside the housing 10 and the panel 60 forms an opening or through hole 64 corresponding to the sensor 50 to allow the sensor 50 to expose through the panel 60. However, it is apparent that the sensor 50 can also be arranged outside the housing 10, similar to the light-emitting diode 30. In this arrangement, the light-emitting diode 30 can be set at any desired location, either inside or outside the housing 10, to provide enhanced practicability and convenience.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An electrical device comprising:
a housing forming an interior space;
a circuit board arranged in the interior space of the housing and electrically connected to at least one light-emitting diode, the circuit board being adapted to electrically connect to an external power source;
at least one socket arranged inside the housing and adapted to electrically connect to the external power source;
a sensor electrically connected to the circuit board and further electrically connected to the light-emitting diode via the circuit board to form a circuit; and
a panel releasably mounted to the housing and forming a first opening corresponding to each of the at least one socket.

2. The electrical device as claimed in claim 1, wherein the sensor and the at least one light-emitting diode are arranged outside the housing and wherein the housing further comprises a retainer plate arranged between the panel and the housing, the retainer plate forming a second opening corresponding to each of the at least one socket and the first opening defined in the panel for positioning the socket and exposing the socket through the panel.

3. The electrical device as claimed in claim 1, wherein the at least one light-emitting diode and the sensor are arranged inside the housing and wherein the housing further comprises a retainer plate arranged between the panel and the housing, the retainer plate forming a second opening corresponding to each of the at least one socket and the first opening defined in the panel for positioning the socket and exposing the socket through the panel, and wherein the retainer plate further forms a through hole corresponding to each of the at least one light-emitting diode and the panel is light-transmittable so that light emitted from the at least one light-emitting diode is allowed to transmit to outside the housing through the through hole of the retainer plate and the light-transmittable panel.

4. The electrical device as claimed in claim 1, wherein the at least one light-emitting diode and the sensor are arranged inside the housing and wherein the housing further comprises a retainer plate arranged between the panel and the housing, the retainer plate forming a second opening corresponding to each of the at least one socket and the first opening defined in the panel for positioning the socket and exposing the socket through the panel, and wherein the retainer plate further forms a first through hole corresponding to each of the at least one light-emitting diode for transmission of light emitted from the light-emitting diode and the panel forms a second through hole corresponding to each of the at least one light-emitting diode and covered by a light-transmitting cap to allow further transmission of the light emitted from the light-emitting diode, the panel further forming a third through hole corresponding to the sensor to expose the sensor through the panel.

5. The electrical device as claimed in claim 1, wherein the at least one light-emitting diode is arranged in the interior space of the housing and wherein the panel is made light-transmittable.

6. The electrical device as claimed in claim 1, wherein the at least one light-emitting diode and the sensor are arranged in the interior space of the housing and wherein the panel is light-transmittable and forms a through hole corresponding to the sensor to expose the sensor through the panel.

7. The electrical device as claimed in claim 1, wherein the at least one light-emitting diode is arranged in the interior space of the housing and wherein the panel forms a through hole corresponding to the light-emitting diode ad covered by a light-transmitting cap to allow transmission of light emitted from the light-emitting diode.

8. The electrical device as claimed in claim 1, wherein the sensor is arranged in the interior space of the housing and wherein the panel forms a through hole corresponding to the sensor to expose the sensor through the panel.

9. The electrical device as claimed in claim 1, wherein the at least one light-emitting diode is arranged outside the housing.

10. The electrical device as claimed in claim 1, wherein the sensor is arranged outside the housing.
